(19) United States
(12) Patent Application Publication
(10) Pub. No.: US 2017/0024108 A1
(43) Pub. Date: Jan. 26, 2017

(54) DATA PROCESSING DEVICE AND METHOD FOR PROVIDING CONTENT

(71) Applicant: LINE CORPORATION, Tokyo (JP)

(72) Inventor: Shunsuke SUZUKI, Tokyo (JP)

(21) Appl. No.: 15/085,497

(22) Filed: Mar. 30, 2016

(30) Foreign Application Priority Data
Jul. 24, 2015 (JP) 2015-146754

(51) Int. Cl. G06F 3/0481; H04L 12/58

(52) U.S. Cl. CPC G06F 3/04817; H04L 51/04; H04L 51/10

(57) ABSTRACT

According to the content providing method related to one embodiment of the present invention, a data processing device receives a first content from a terminal of a first user, the data processing device receives a second content from a terminal of a second user displayed by the first content, and provides a third content based on a combination of the first content and the second content to the terminal of the first user and a terminal of the second user.

### CROSS-REFERENCE TO RELATED APPLICATIONS

This application is based upon and claims the benefit of priority from the prior Japanese Patent Application No. 2015-146754, filed on Jul. 24, 2015, the entire contents of which are incorporated herein by reference.

### FIELD

The present invention is related to a data processing device and a method for providing different content using a content identifier. In particular, the present invention is related to a data processing device and a method for providing different content based on a combination of an immediately previous plurality of content identifiers.

### BACKGROUND

Various services using the internet are being developed together with the rapid increase in expansion of the internet market in recent years. In particular, services in which data is exchanged between users such as electronic mail and electronic chat are being developed.

At the initial stage of these services, only text data was transmitted. However, just with text data alone, receiver needs to guess the purpose or intention of the transmitter after reading and interpreting the text. Thus, not only text but also decorated text (pictograph and emoticon etc) and image data (for example, images, screenshots etc) began to be transmitted. However, there are problems that the decorated text and image data do not match text data, and do not match the context of a conversation because the transmitter selects the decorated text or image data at random.

Therefore, a method for visual expression using characters corresponding to text data (for example, Japanese Laid Open Patent No. 2000-207304 (patent document 1)), or a method for supporting the creation of a response message based on history data of mail exchange (for example, Japanese Laid Open Patent No. 2007-200159 (patent document 2)) have been proposed. That is, a method is disclosed in the patent document 1 in which it is possible to form expressions such as laughter when the content is [happy] and tears when the content is [sad] by registering character expressions to be displayed in a screen according to the content of a conversation in advance. In addition, a method is disclosed in the patent document 2 in which decorated text (pictograph/emoticon) which has the effect of increasing enjoyment is automatically added to the main text by using a corresponding table.

### SUMMARY

According to one embodiment of the present invention, a method of providing a content is provided comprising receiving a first content from a terminal of a first user by a data processing device, receiving a second content from a terminal of a second user displayed by the first content by the data processing device, and providing a third content based on a combination of the first content and the second content to a terminal of the first user and a terminal of the second user.

In another preferred embodiment, providing the third content may be performed based on combination data of the first content, the second content and the third content set in advance.

In another preferred embodiment, the first content or the second content may have combination data including the second content and the third content.

In another preferred embodiment, the data processing device may have combination data of the first content, the second content and the third content.

In another preferred embodiment, the first content or the second content may be at least one from among a keyword, an image, music, video, weather data, time data and location data.

In another preferred embodiment, the third content may be at least one from among an event, a program, music, video, an image and animation.

According to one embodiment of the present invention, a data processing device is provided including a receiving part configured to receive a first content from a terminal of a first user and a second content from a terminal of a second user, a transmitting part configured to transmit the received first content to the second user and the received second content to the first user, and a content provision part configured to provide a third content based on a combination of the first content and the second content to a terminal of the first user and a terminal of the second user.

In another preferred embodiment, a content data reading part configured to read data of the first content and the second content may be further comprised.

In another preferred embodiment, the content providing part may provide the third content based on combination data of the first content, the second content and the third content set in advance.

In another preferred embodiment, a content data storage part including combination data of the first content, the second content and the third content may be further included.

In another preferred embodiment, the first content or the second content may be at least one from among a keyword, an image, music, video, weather data, time data and location data.

In another preferred embodiment, the third content may be at least one from among an event, a program, music, video, an image and animation.

According to the different content providing method using a content identifier related to the present invention, it is possible to reflect an exchange of data between users.

### BRIEF DESCRIPTION OF THE DRAWINGS

FIG. 1 is a block diagram showing an example of a structure of a chat system related to one embodiment of the present invention;

FIG. 2 is a block diagram showing an example of a terminal device and a structure of a chat server related to one embodiment of the present invention;

FIG. 3 is a concept diagram for explaining a case where an event handler has a table related to one embodiment of the present invention;

FIG. 4 is a diagram showing an example structure of a table related to one embodiment of the present invention;

FIG. 5 is a diagram showing an example of generating an event related to one embodiment of the present invention;

FIG. 6 is a diagram showing an example in the case where an event is not generated;

FIG. 7 is a diagram showing an example of generating an event related to one embodiment of the present invention;

FIG. 8 is flow diagram showing a sequence for providing different content using a content identifier related to one embodiment of the present invention;

FIG. 9 is flow diagram for suggesting different content using a content identifier related to one embodiment of the present invention;

FIG. 10 is a concept diagram for explaining a suggestion function related to one embodiment of the present invention;

FIG. 11 is a concept diagram for explaining a case where a content has a table related to another embodiment of the present invention;

FIG. 12 is a concept diagram for explaining a case where a chat server has a table related to another embodiment of the present invention; and

FIG. 13 is flow diagram showing a sequence for providing different content using a content identifier related to one embodiment of the present invention.

### DESCRIPTION OF EMBODIMENTS

One embodiment of the present invention is explained in detail below while referring to the drawings. The embodiments shown herein are examples of the embodiments of the present invention and the present invention is not limited to these embodiments. Furthermore, the same or similar symbols (symbols where only A, B etc. are attached after a number) are attached to the same components or components having the same function and therefore repeated explanations may be omitted. In addition, from the viewpoint of ease of understanding, even when the value of data stored in a [˜storage part] is actually [0] or [1], the value is expressed as what the data means.

Both the method of the patent document 1 and the patent document 2 go no further than automatically adding characters or decorated text (pictograph/emoticon) corresponding to the text data expressed by a transmitter, and do not reflect the exchange of data between users.

The present invention attempts to solve the problems associated with the conventional technology described above and an aim of the present invention is to reflect the exchange of data between users.

### [Structure of a Chat System]

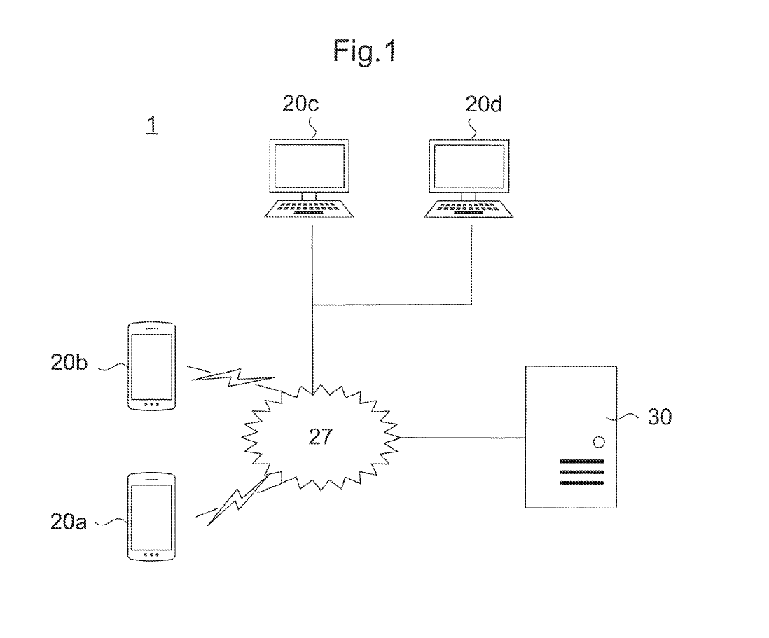

An overview of a chat system 1 is explained using FIG. 1. FIG. 1 is a block diagram showing an example of a structure of a chat system related to one embodiment of the present invention. The chat system 1 comprises a user terminal 20, network 27 and chat server (data processing device) 30. The chat server 30 is connected to each user terminal 20a, user terminal 20b, user terminal 20c and user terminal 20d via the network 27 respectively. Furthermore, a terminal is denoted as [user terminal 20] in the case where it is not necessary to distinguish between user terminals.

Here, the network 27 is a network such as a LAN (local area network) or the internet for example, and a network environment in which the user terminal 20 can connect to the chat system 1 is applied regardless of whether it is a wireless, wired line or dedicated line network.

In addition, the user terminal 20 comprises a mobile communication terminal device such as a multi-function mobile phone, mobile phone, FDA (Personal Digital Assistant) or a data processing terminal device etc. arranged with a communication function and calculation function such as a personal computer. In addition, the user terminal 20 comprises a browser as a display control function for displaying a screen provided by the chat server 1, CPU, memory, and a communication control part which implement communication control with chat server 1. Furthermore, the user terminal 20 comprises an operation input device such as a mouse, keyboard, touch panel etc. and display device.

### [Structure of a User Terminal]

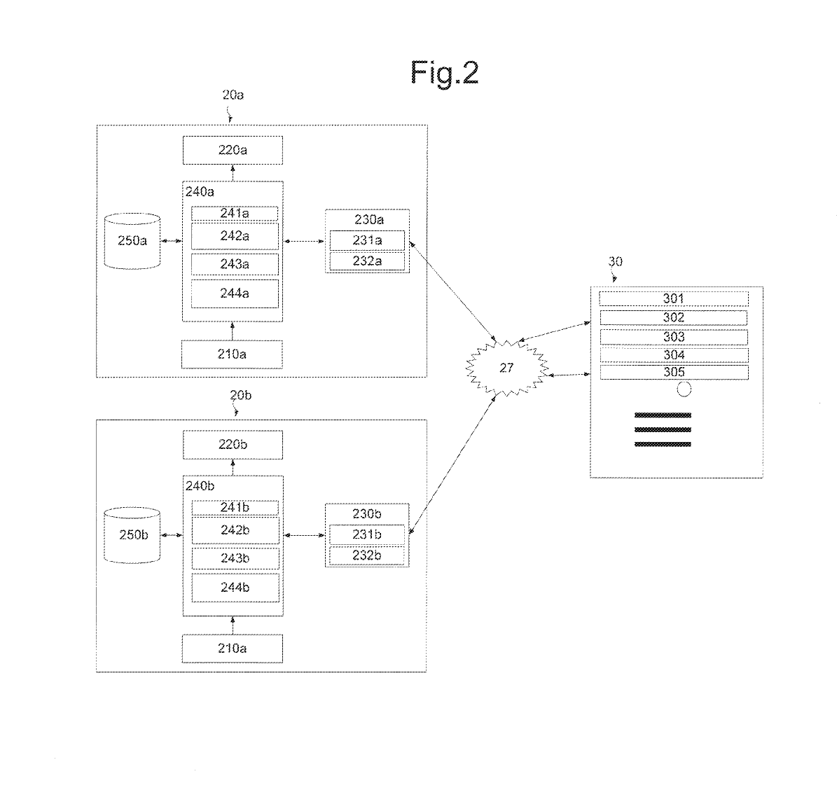

An overview of the user terminal 20 is explained using FIG. 2, FIG. 2 is a block diagram showing an example of a structure of a terminal device and chat server related to one embodiment of the present invention. Although a user terminal 20a, user terminal 20b and each component of user terminal 20a and 20b are shown in FIG. 2, an explanation is given of just a user terminal 20 when no particular distinction is made. The user terminal 20 comprises a data input part 210, a display part 220, a data communication part 230, a control part 240 and a storage part 250.

The data input part 210 is an interface for receiving each type of command from a user and there is no particular limitation to its specific reception method. Usually, a keyboard method, touch panel method, touch stick method or a compound method combining two or more of these is used. In addition, a voice signal may also be input.

The display part 220 displays an output of data processed by the user terminal 20. Although the display part is formed by a LCD or organic EL for example, the display part is not limited to these and any known technology can be used.

The data communication part 230 comprises a transmitting part 231 for transmitting data and a receiving part 232 for receiving data. The transmitting part 231 transmits a first content including an identifier which serves as a trigger and a second content including an identifier which serves as a condition. The receiving part 232 receives the first content and the second content. Details with respect to the first content and the second content are described herein.

The control part 240 comprises a display control part 241, an event generation part 242, a communication control part 243 and a content confirmation part 244. The display control part 241 has a function for displaying the first content and second content in the display part 220. The communication control part 243 has a function for outputting a command for transmitting data or and transmitting the data to the transmitting part 231 when, for example, an icon which transmits the data from the data input part 210 is selected. The event generation part 242 generates an event displayed with a third content based on a combination of an identifier of the first content and an identifier of the second content. The content confirmation part 244 transmits a signal to the chat server 30 for commanding the generation of an event in which the third content is displayed in the case where it is confirmed that the third content is not stored in the storage part 250.

The storage part 250 can store a program for operating the control part 240 and can store input data (messages, images, video etc.). The storage part 250 may comprise at least one type of storage media from among a flash memory type, hard disk type, multimedia card micro type, card type memory (for example, SD or XD memory), Random Access Memory, Static Random Access Memory, Read-Only Memory, Electrically Erasable Programmable Read-Only Memory, Programmable Read-Only Memory, Magnetic Memory, Magnetic Disk or Optical Disk.

### [Structure of a Chat Server]

The chat server 30 comprises a receiving part 301, transmitting part 302, content providing part 303, content data reading part 304 and content data storage part 305.

The receiving part 301 receives the first content which has an identifier which serves as a condition from the user terminal 20a of a first user. In addition, the receiving part 301 receives the second content which has an identifier which serves as a trigger from the user terminal 20b of a second user.

The transmitting part 302 transmits the first content received from the user terminal 20a of the first user to the user terminal 20b of the second user. In addition, the transmitting part 302 transmits the second content received from the user terminal 20b of the second user to the user terminal 20a of the first user.

The content identifier data reading part 303 reads the identifier of the first content and the identifier of the second content.

The content providing part 304 provides a third content based on a combination of the identifier of the first content and the identifier of the second content to the user terminal 20a of the first user and the user terminal 20b of the second user.

The content data storage part 305 has a data combination of the first content, second content and third content.

### First Embodiment

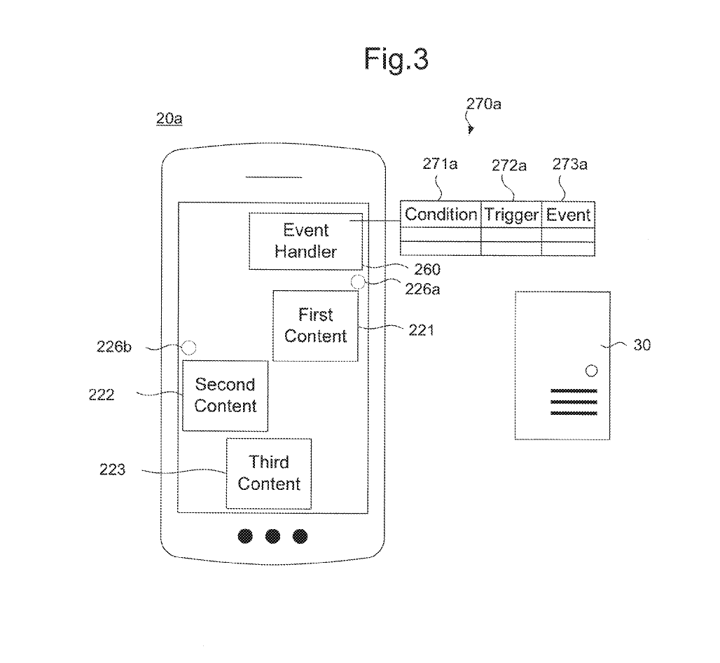

The case where an event handler has a table is explained using FIG. 3. FIG. 3 is a concept diagram for explaining the case where an event handler has a table related to one embodiment of the present invention. A chat application is initiated and a chat in progress is displayed in the display part of the user terminal 20a. In this example, after the first content 221 is transmitted from the user terminal 20a so that a user icon 226a and the first content 221 are displayed in almost the right half of the screen, the second content 222 is transmitted from the user terminal 20b so that a user icon 226b and the second content 222 are displayed in almost the left half of the screen. Although the user icon 226a and user icon 226b are displayed in this example, the present invention is not limited to these and any image or character may be used as long as it identifies a user. Furthermore, although the contents are displayed on the right hand side of a display part of a terminal in the case where the contents are transmitted from the terminal, the present invention is not limited to this and content may be displayed on the left hand side or in the middle of the screen. In addition, although an event handler 260 is displayed on an upper end of a screen in FIG. 3, the event handler 260 is not displayed in the display part of the actual user terminal 20 for the convenience of explanation. The same is true in the explanation herein.

The event handler generates a process based on a condition and trigger. A condition refers to an event or data which is a condition for generating an event, and a trigger refers to an event or data which is a trigger for generating an event. If there is no condition, a trigger is never generated. In addition, even if there is a condition, an event is never generated if there is no trigger. A condition 271a, trigger 272a and event 273a are defined in a table 270a. In the present embodiment, the event handler 260 has the table 270a.

Here, an identifier (ID, keyword etc.) of the first content 211 is defined in the condition 271a, an identifier (ID, keyword etc.) of the second content 222 is defined in the trigger 272a, and in this case, event is defined that the third content 223 is transmitted. After the first content 221 is transmitted from the user terminal 20a so that a user icon 226a and the first content 221 are displayed in almost the right half of the screen, and the second content 222 is transmitted from the user terminal 20b so that a user icon 226b and the second content 222 are displayed in almost the left half of the screen, an event is generated whereby the third content 223 is displayed in almost the middle of the screen. Although the third content 223 is displayed in almost the middle of the screen in this example, the location where the content is displayed is not limited to this, the display location may be almost the right half of the screen where the first content is displayed or the almost left half of the screen where the second content is displayed. Furthermore, the first content, second content and third content may sometimes include an identifier and may not include an identifier.

### [Structural Example of a Table and Event Example]

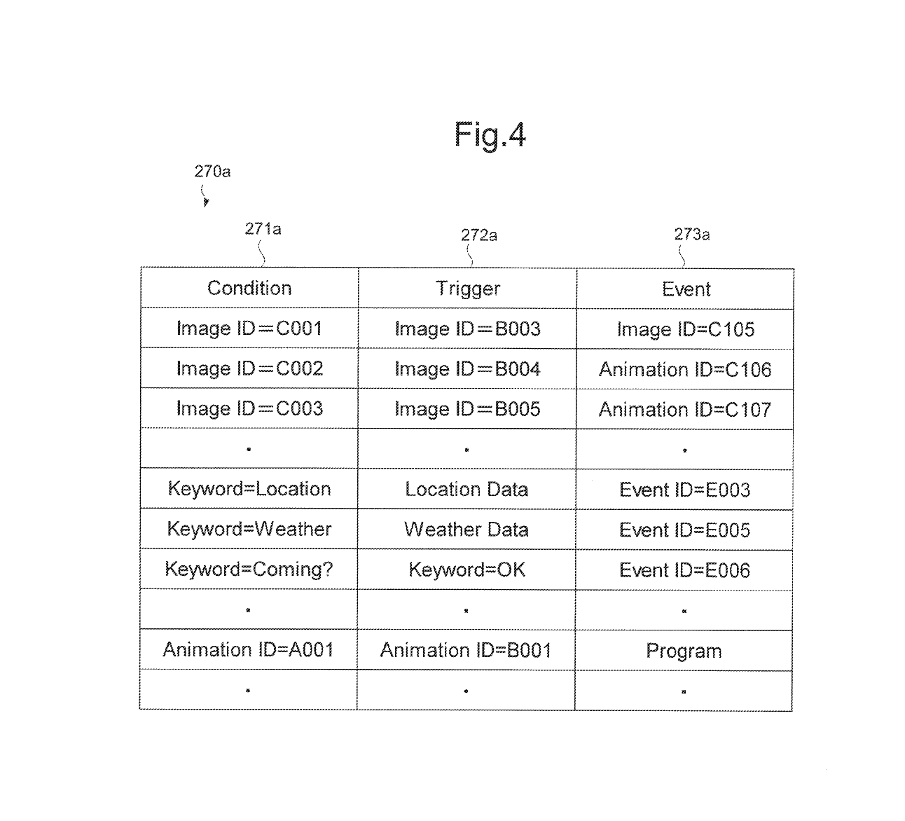

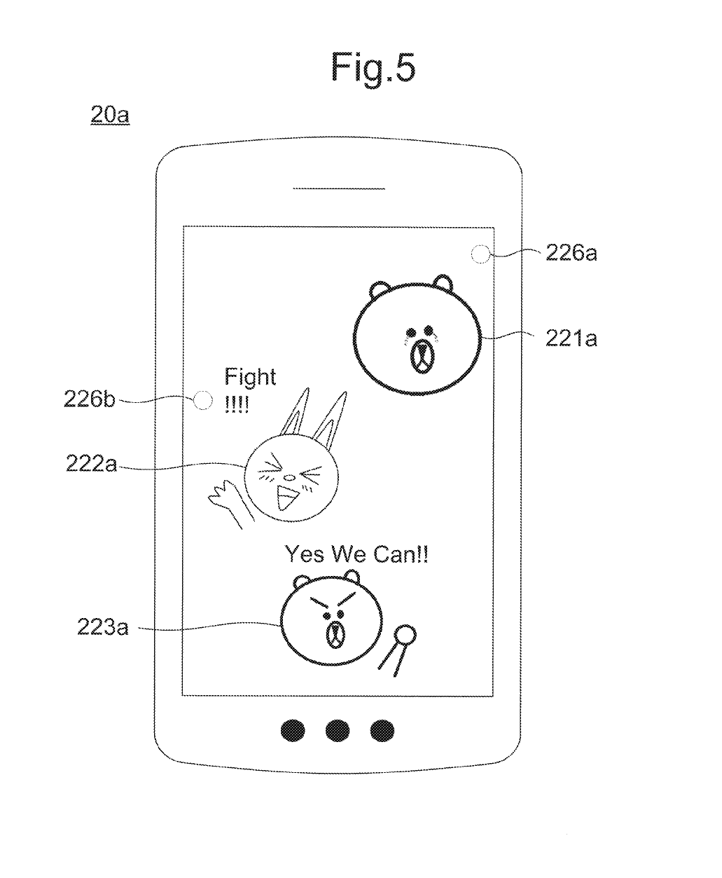

A value which enters each column of a condition, trigger and an event and a generated event are explained using FIG. 4 and FIG. 5. FIG. 4 is a diagram showing a structural example of a table related to one embodiment of the present invention.

Although an image ID, keyword, and an animation (video) ID are entered into the condition 271 column as in FIG. 4, FIG. 5 is not limited to this and a music ID, weather data, time data or location data may also be entered. Although a music ID, weather data, keyword and animation ID are entered in the trigger 272a column, the present invention is not limited to this and a music ID may also be entered. Although an image ID, animation ID, event ID and program are entered in the event 273a column, the present invention is not limited to this, a frame number or content other than a chat such as video, text message, store data or URL link may also be entered. A program which plays music or a program which initiates a map function may be used as the program for example. Specifically, when a program for playing music is executed, music automatically plays in the background. A music providing function may be initiated or a different application linked to a chat application may be used as a music play method. In addition, with respect to a map function, a map function program may be automatically initiated to display a map of the present location and surroundings, a different map application to a chat application may be linked to and initiated or a map of the present location and surroundings may not be displayed at all.

For example, as is shown in FIG. 4, since [image ID=C105] is entered to the event 273a column when [image ID=C001] is entered to the condition 271a column and [image ID=B003] is entered to the trigger 272a column, in the case where [image ID=C001] is transmitted as the first content and [image ID=B003] is transmitted as the second content, [image ID=C001] is displayed in the display part of a user terminal. Specifically, as is shown in FIG. 5, a character image (corresponding to [image ID=C001]) of the expression [cried] is transmitted as the first content 221a from the user terminal 20a of the first user, and a character image (corresponding to [image ID=B003]) urging [Fight!!!!] is transmitted as the second content 222a from the user terminal 20b of the second user. After these images, a character image (corresponding to [image ID=C105]) which is initiated as [Yes We Can!!] is automatically displayed in the display part.

According to the present embodiment, it is possible to provide content which reflects the exchange of user data. In this way, it is possible to achieve smooth communication. In addition, an event corresponding to a condition and trigger is automatically generated. That is, users themselves do not know what type of event is actually generated. As a result, a user can chat while looking forward to what type of event will be generated.

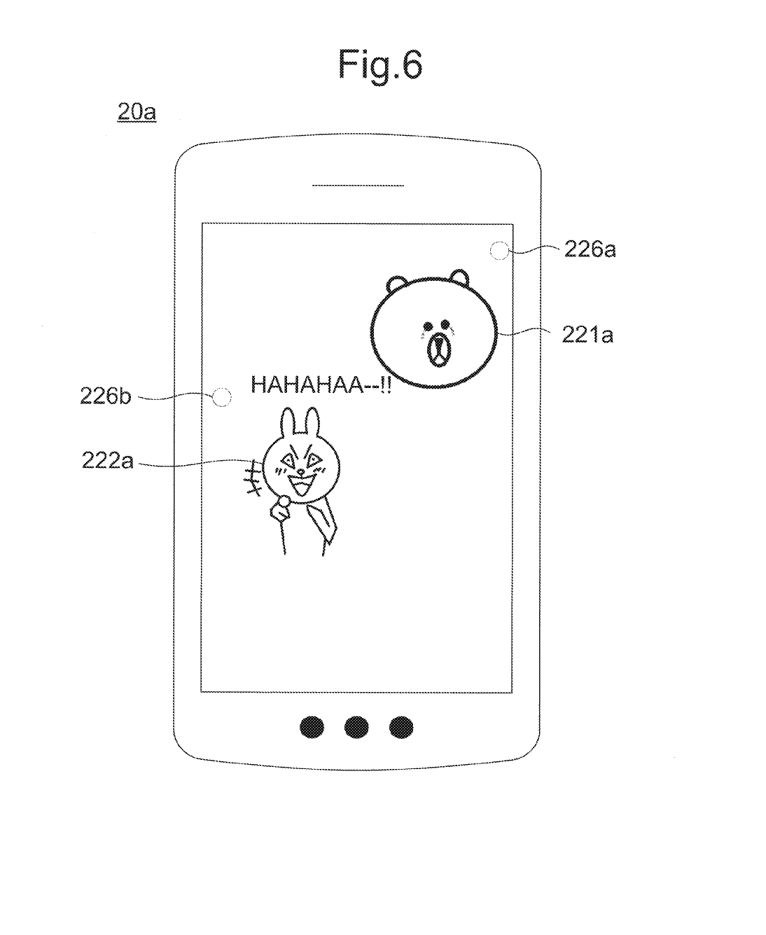

Alternatively, even if there is a condition, if there is no trigger, an event is not generated. FIG. 6 shows an example in the case where an event is not generated. As is shown in FIG. 6, a character image (corresponding to [image ID=C001]) of an expression [cried] is transmitted as the first content 221a from the user terminal of the first user. However, what is transmitted from the user terminal of the second user is the poke fun character image [HAHAHAA—!!] as the second content 222b. This poke fun character image is not entered to a trigger column corresponding to the character image (corresponding to [image ID=C001]) of the expression [cried] in the table. As a result, the third content is never displayed in the display part.

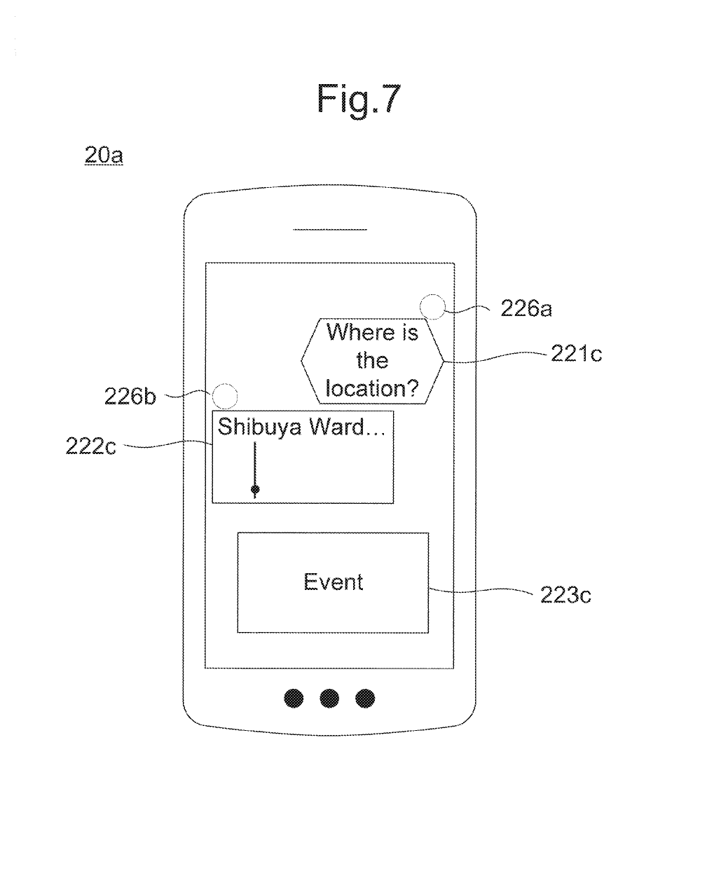

FIG. 7 is a diagram showing an example of generating an event related to one embodiment of the present invention. As is shown in FIG. 4, when [keyword=location] is entered to the condition 271a column and [location data] is entered to the trigger 272a column, [event ID=E003] is entered to the event 273a column. As is shown in FIG. 7, a message [where is the location?] (corresponding to [keyword=location]) is transmitted as the first content 221c from the user terminal 20a of the first user, and the location data (corresponding to [location data]) [Shibuya Ward . . . ] is transmitted as the second content 222c from the user terminal 20b of the second user. Next, an event corresponding to [event ID=E003] is automatically displayed in the display part. Here, the event ID is not a program itself but a reference ID of a program which is described and a program corresponding to this ID is called and executed.

In the above explanation, the case where an image ID or event ID is entered to the event 273a column was explained. Next, the case where a value is not entered to the event 273a column is briefly explained. For example, in the case where an animation ID is entered to the event 273a column, that ID is called and executed (the animation is played). In addition, for example, in the case where a program is entered to the event 273a column, specifically, in the case where a program with the content [animation of animation ID=C107 is executed in image A which serves as a condition and image B which serves as a trigger is described, this program is executed. In addition, for example, in the case where a frame number is entered to the event 273a column, an animation from a certain frame to be played is specified and the animation is played from that frame.

### [Content Providing Method]

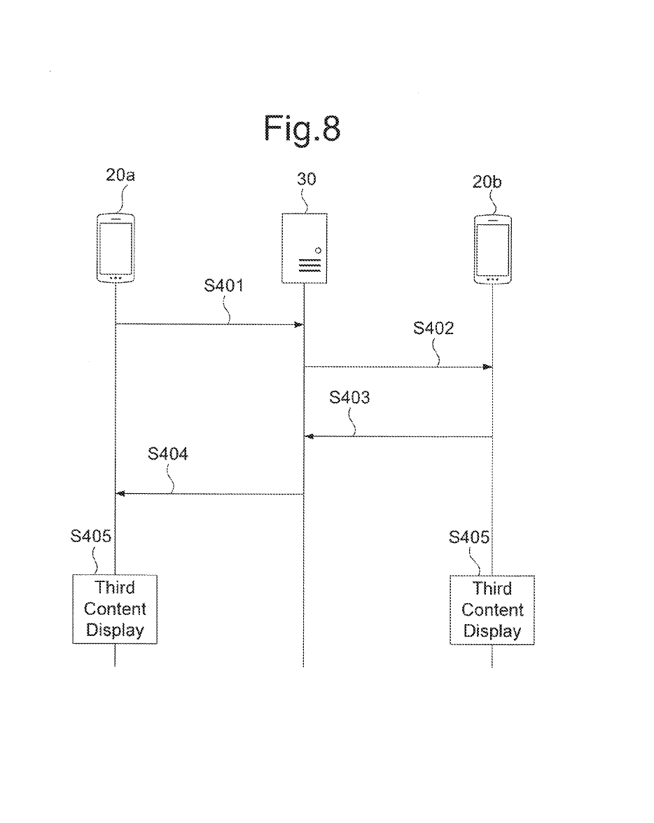

A method of providing content is explained using FIG. 8. FIG. 8 is a flow diagram showing a sequence for providing different content using a content identifier related to one embodiment of the present invention. Although a chat is shown in this example where a first user and a second user use user terminal 20a and user terminal 20b respectively, from the viewpoint of ease of understanding, the number of users who can join a chat is not limited to two people and may be three people or more.

First, the first user transmits a first content from the user terminal 20a to the chat server 30 so that the first content is displayed in the display part of the user terminal 20b of the second user (S401). Next, the chat server 30 transmits the first content to the user terminal 20b of the second user (S402). Furthermore, in this example the first content itself is stored in the storage part 250 of the user terminal 20a of the first user. As a result, even if the first content is transmitted from the user terminal 20a to the chat server 30 by the first user, the chat server 30 transmits the first content only to the user terminal 20b and does not transmit the first content to the user terminal 20a. The first content being displayed in the display part of the user terminal 20a of the first user simply means that the first content stored in the storage part of the user terminal 20a of the first user is displayed in the display part.

Next, the second user transmits the second content to the chat server 30 from the user terminal 20b so that the second content is displayed in the display part of the terminal 20a of the first user (S403). Next, the chat server 30 transmits the second content to the user terminal 20a of the first user (S404). Lastly, the third content is displayed in the display part of the user terminal 20a of the first user and the user terminal 20b of the second user based on a trigger and condition (S405)

### [Suggestion Function]

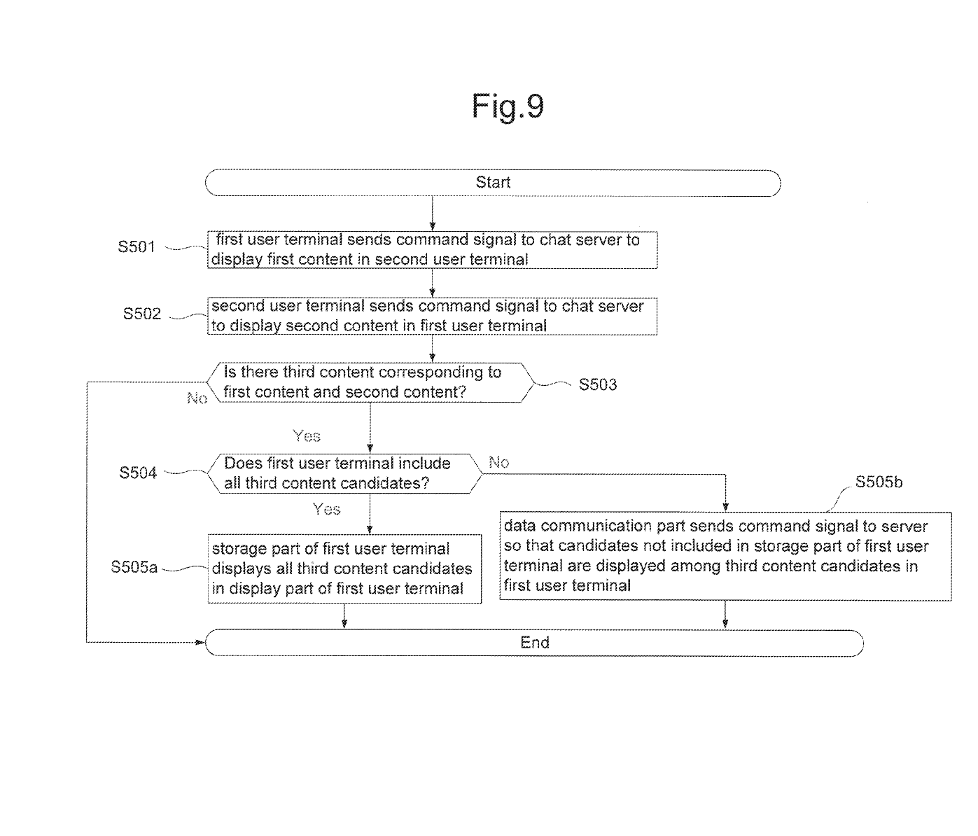

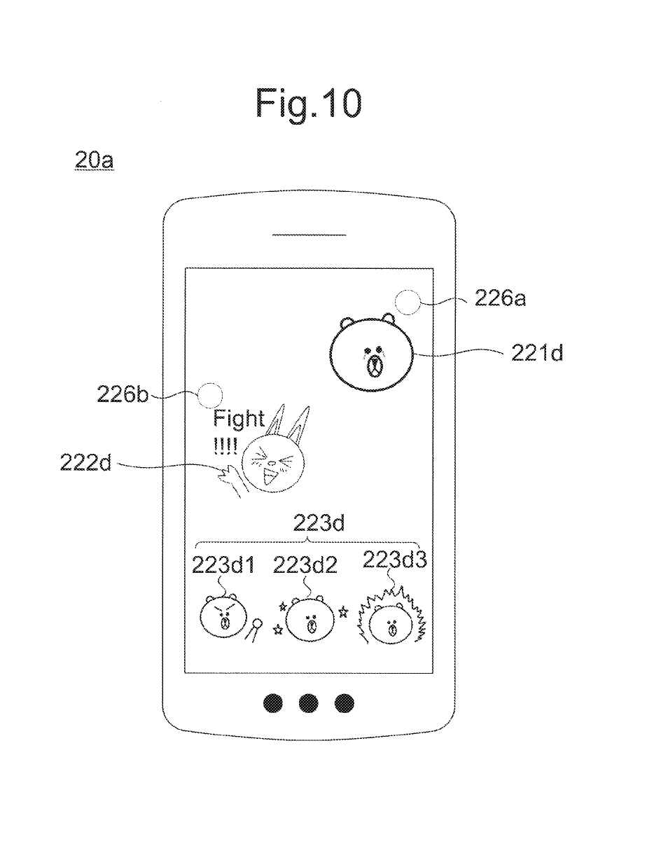

In the explanation given above, if the third content is already stored in the storage part of the user terminal 20, it is assumed that an image is displayed by an event or an animation is to be played. Therefore, a function in which the chat server 30 suggests (proposes a purchase) to a user a candidate for the third content corresponding to the first content and second content is explained below using FIG. 9 and FIG. 10. FIG. 9 is a flow diagram for suggesting a different content using a content identifier related to one embodiment of the present invention.

First, the user terminal 20a of the first user transmits the first content to the chat server 30 so that the first content is displayed in the user terminal 20b of the second user (S501). After the first content is displayed in the user terminal 20b of the second user, the user terminal 20b of the second user transmits the second content to the chat server 30 so that the second content is displayed in the user terminal 20a of the first user (S502). Next, the content confirmation part 243 confirms whether the first content has become a condition and whether the first content includes a table which becomes a trigger (S503). If the table is not present (No in S503), an event is not generated and the flow ends.

Alternatively, if a table is present (Yes in S503), moreover, in the case where an event to display the third content is present, the content confirmation part 243 confirms whether all of the candidates of the third content are present in the storage part 250 of the user terminal 20a of the first user (S504). Here, if it is confirmed that all of the candidates of the third content are present in the storage part 250 of the user terminal 20a of the first user (Yes in S504), the storage part 250a of the user terminal 20a of the first user displays all the candidates of the third content in the display part 220a of the user terminal 20a of the first user (S505a). Furthermore, although the display here is a pre-display meaning that it is displayed in advance as a selection option, when the first user selects any one from the candidates of the third content displayed in the pre-display, the selected third content is displayed in the user terminal 20a of the first user. Here, if it is confirmed that the third content is present in the storage part 250 of the user terminal 20a of the first user (Yes in S504), the user terminal 20a of the first user transmits the third content to the chat server 30 so that the third content is displayed in the user terminal 20b of the second user (S505a).

If it is confirmed that all of the candidates of the third content are not present in the storage part 250a of the user terminal 20a of the first user (No in S504), the data communication part 230a of the user terminal 20a of the first user transmits data showing data of the candidates which are not present in the storage part 250a of the user terminal 20a of the first user among the candidates of the third content to the chat server 30 (S505b). Specifically, in the case where [image A], [image B] and [image C] are present as candidates of the third content, if none of the candidates are present in the storage part 250a of the user terminal 20a, the data communication part 230a transmits data to the chat server 30 showing that [image A], [image B] and [image C] are not present. Alternatively, if [image A] is present in the storage part 250a of the user terminal 20a, the data communication part 230a transmits data to the chat server 30 showing that [image B] and [image C] are not present. The chat server 30 which receives this data reads the candidate of the third content which is not present in the terminal 20a of the first user from an internal database of the chat server 30 or an external database and displays the third content in the display part of the user terminal 20a of the first user.

The case where the chat server 30 displays the third content in the display part of the user terminal 20a of the first user is explained using FIG. 10. FIG. 10 is a concept diagram for explaining a suggestion function related to one embodiment of the present invention. As is shown in FIG. 10, the first content 221d is transmitted from the user terminal 20a of the first user and the second content 222d is transmitted from the user terminal 20b of the second user. Next, 223d1 to 223d3 are displayed as candidates of the third content 223d to the display part of the user terminal 20a of the first user. The image 223d1 is a character image [raise hand and cheer], the image 223d2 is a character image [moved], and the image 223d3 is a character image [raring to go]. The first user can purchase a desired image from among these images 223d1 to 223d3.

According to the present invention, it is possible to provide content which reflects the exchange of user data using a suggestion function. In addition, in the case of a system for purchasing images, moreover, in the case where there are many images that can be purchased, a user can purchase an image matching the context of a conversation without having to search for images to purchase themselves.

### Second Embodiment

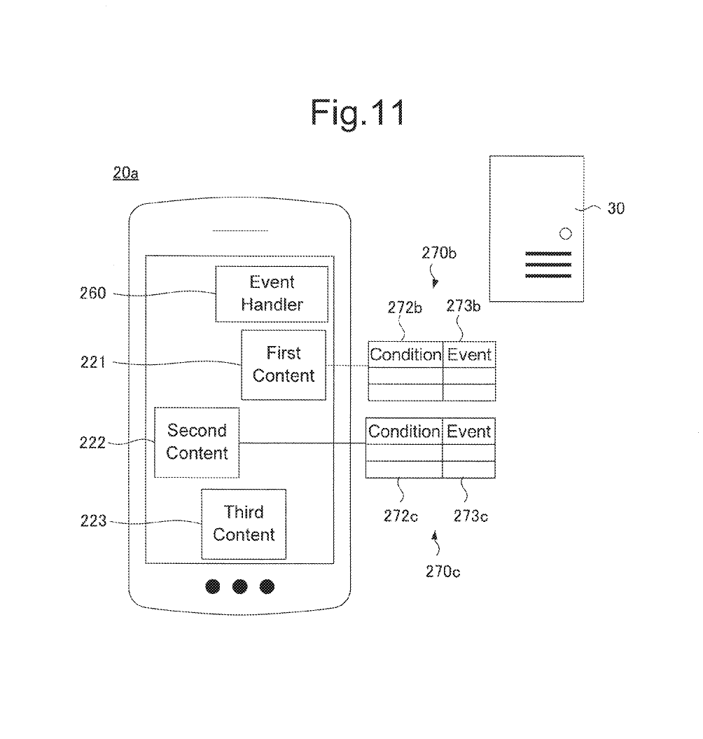

The case where a content includes a table is explained using FIG. 11. FIG. 11 is a concept diagram for explaining the case where a content includes a table related to another embodiment of the present invention. The present embodiment is almost the same as the first embodiment except the point where a content includes a table. Therefore, only different parts are explained and an explanation of parts which overlap is omitted. In the present embodiment, the content itself includes a table. If the content itself includes a table, since the content itself becomes a trigger, a condition and an event are entered to the table.

The values entered to a condition column or event column in a table are the same as in the first embodiment. In addition, the event handler 260 which generates an event entered to a table or includes a suggestion function is also the same as in the first embodiment.

According to the present embodiment, it is possible to provide content which reflects the exchange of user data. In this way, it is possible to achieve smooth communication. In addition, an event corresponding to a trigger or condition is automatically generated. That is, users themselves do not know what type of event is actually generated. As a result, user can chat while looking forward to what type of event will be generated.

### Third Embodiment

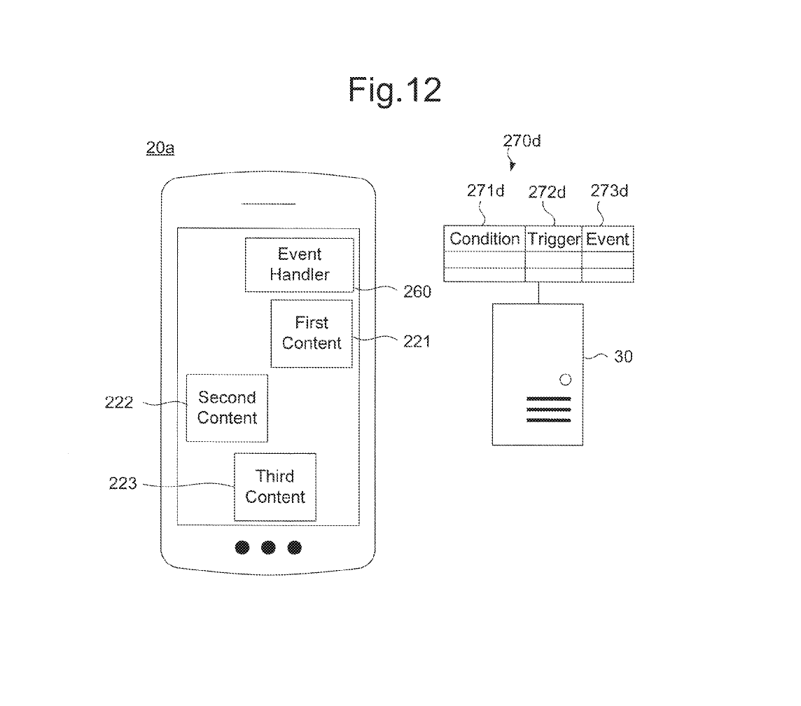

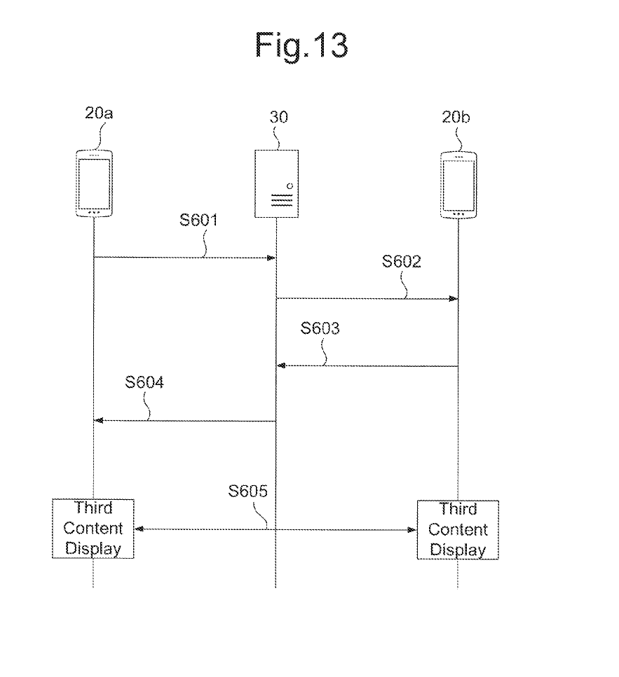

The case where the chat server 30 has a table is explained using FIG. 12 and FIG. 13. FIG. 12 is a concept diagram for explaining the case where a chat server has a table related to another embodiment of the present invention. The present embodiment is almost the same as the first embodiment except the point where the chat server 30 has a table. Therefore, only different parts are explained and an explanation of parts which overlap is omitted. If the chat server 30 has a table, the sequence for providing different content using a content identifier is different to the first and second embodiments.

FIG. 13 is a flow diagram showing a sequence for providing different content using a content identifier related to another embodiment of the present invention. S601 to S604 in FIG. 13 are the same as S401 to S404 in FIG. 8. As a result, an explanation of S601 to S604 is omitted. After S604, lastly, the chat server 30 transmits a command signal so that the third content is displayed in the display part of the user terminal 20a of the first user and the user terminal 20b of the second user. Each user terminal which receives this command displays the third content in a display part respectively S605).

The values entered to a condition column or event column in a table are the same as in the first embodiment. In addition, the event handler 260 which generates an event entered to a table or has a suggestion function is also the same as in the first embodiment.

According to the present embodiment, it is possible to provide content which reflects the exchange of user data. In this way, it is possible to achieve smooth communication. In addition, an event corresponding to a trigger or condition is automatically generated. That is, users themselves do not know what type of event is actually generated. As a result, user can chat while looking forward to what type of event will be generated.

Furthermore, possession of a table is not limited to an event handler, content or chat server described above. For example, a means which can have a table is possible such as a means for storage in a storage means (memory for example) within a user terminal.

Furthermore, the present invention is not limited to the embodiments described above and can be appropriately changed within a scope that does not depart from the concept of the invention.

### REFERENCE SYMBOLS

1: Chat System
20: User Terminal
27: Network
30: Chat Server
210: Data Input Part
220: Display Part
221: First Content
222: Second Content
223: Third Content
226: User Icon
230: Data Communication Part
231: Transmitting Part
232: Receiving Part
240: Control Part
241: Display Control Part
242: Event Generation Part
243: Communication Control Part
244: Content Confirmation Part
250: Storage Part
260: Event Handler
270: Table
271: Condition
272: Trigger
273: Event
301: Receiving Part
302: Transmitting Part
303: Content Data Reading Part
304: Content Providing Part
305: Content Data Storage Part

What is claimed is:

1. A method for providing a content comprising:
receiving a first content from a terminal of a first user by a data processing device;
receiving a second content from a terminal of a second user displayed by the first content by the data processing device; and
providing a third content based on a combination of the first content and the second content to a terminal of the first user and a terminal of the second user.

2. The method for providing a content according to claim 1, wherein providing the third content is performed based on combination data of the first content, the second content and the third content set in advance.

3. The method for providing a content according to claim 1, wherein the first content or the second content has combination data including the second content and the third content.

4. The method for providing a content according to claim 1, wherein the data processing device has combination data of the first content, the second content and the third content.

5. The method for providing a content according to claim 2, wherein the first content or the second content is at least one from among a keyword, an image, music, video, weather data, time data and location data.

6. The method for providing a content according to claim 2, wherein the third content is at least one from among an event, a program, music, video, an image and animation.

7. A data processing device comprising:
a receiving part configured to receive a first content from a terminal of a first user and a second content from a terminal of a second user;
a transmitting part configured to transmit the received first content to the second user and the received second content to the first user; and
a content provision part configured to provide a third content based on a combination of the first content and the second content to a terminal of the first user and a terminal of the second user.

8. The data processing device according to claim 7, wherein a content data reading part configured to read data of the first content and the second content is further comprised.

9. The data processing device according to claim 7, wherein the content providing part provides the third content based on combination data of the first content, the second content and the third content set in advance.

10. The data processing device according to claim 7, wherein a content data storage part including combination data of the first content, the second content and the third content is further included.

11. The data processing device according to claim 8, wherein the first content or the second content is at least one from among a keyword, an image, music, video, weather data, time data and location data.

12. The data processing device according to claim 8, wherein the third content is at least one from among an event, a program, music, video, an image and animation.
